(19) United States
(12) Patent Application Publication
(10) Pub. No.: US 2018/0227429 A1
(43) Pub. Date: Aug. 9, 2018

(54) NON-GEOGRAPHIC NUMBERING AND CALL ROUTING

(71) Applicant: Neustar, Inc., Sterling, VA (US)

(72) Inventor: Thomas G. McGarry, Arlington, VA (US)

(21) Appl. No.: 15/426,803

(22) Filed: Feb. 7, 2017

(51) Int. Cl. H04M 7/00; H04L 29/06; H04M 3/22

(52) U.S. Cl. CPC H04M 7/0075; H04M 2207/203; H04M 3/229; H04L 65/1069

(57) ABSTRACT

Systems and methods for non-geographic numbering, addressing, managing, and routing calls through a telecommunications network. Particularly, this invention relates to the concept of a parallel IP-based telecommunications network which can manage and route calls to a non-geographic telephone number. The invention further relates to nationwide number portability (NNP), that is, porting telephone numbers across different geographies and routing calls to the ported telephone numbers via a new architecture that includes an IP transport provider, IP tandems and an administrative agency that administers non-geographic routing numbers and non-geographic telephone numbers. According to disclosed embodiments, the system and method allow a service provider to route calls to a telephone number which is not dependent on a geographic area code. The system and method further allow a service provider to port a geographic telephone number to a non-geographic telephone number, while keeping and/or changing the service provider associated with the telephone number.

### TECHNICAL FIELD

This following disclosure relates to systems and methods for non-geographic numbering, addressing, managing, and routing calls through a telecommunications network. Particularly, the following disclosure relates to the concept of non-geographic numbers, including porting telephone numbers across different geographies and routing calls to the non-geographic and ported telephone numbers via an architecture that can include an IP transport provider, IP tandems and/or an administrative agency that administers non-geographic telephone and routing numbers.

### BACKGROUND AND SUMMARY

The United States telecommunications network is also called the Public Switched Telephone Network (PSTN). Basic elements of the PSTN 100 are depicted in FIG. 1A and include; end office switches (EO) 102a . . . 102n, tandem switches 104, lines 106a . . . 106n and trunks 108a . . . 108n. Switches are nodes in the network that process telephone calls. Lines connect telephones 101a . . . 101n to EOs, and trunks connect switches to other switches. An End Office (EO) has lines and trunks and supports call origination and termination to and from telephones. A tandem only has trunks and connects switches to other switches. A call from one EO to another may go through a tandem.

The PSTN is divided into distinct geographic regions called Local Access and Transport Areas (LATAs), also called exchanges. FIG. 1A depicts a PSTN network within a LATA showing Local Exchange Carrier (LEC) EOs and a LEC tandem. At one time certain LECs were restricted from transporting telephone calls between LATAs. They could transport calls within a LATA, but had to hand off calls between LATAs to an entity called an Interexchange Carrier (IXC). FIG. 1B depicts a network that includes two LATAs 102a and 102b and an IXC.

In addition to LECs and IXCs there are two other types of carriers in the PSTN including: mobile carriers and Competitive Local Exchange Carriers (CLECs). Mobile carriers provide service to cell phone customers and their switches typically connect into the PSTN at the LEC tandem. CLECs are similar to LECs and their switches also typically connect to the PSTN at the LEC tandem. It is also possible for LEC EOs, mobile switches and CLEC switches to connect directly. Some mobile carriers and all CLECs were never required to hand off calls to IXCs. FIG. 1C depicts a network including mobile switches 125a . . . 125n and CLEC switches 130a . . . 130n.

The format of a US telephone number (TN) is NPA-NXX-XXXX. The first three digits is called the NPA (Numbering Plan Area) or area code. The first six digits of a TN is called the central office (CO) code. CO codes for geographic TNs are assigned to a specific service provider and switch. The full ten digits is called the line number, which is ultimately assigned to users. For example, for the TN (571) 434-5400, 571 is an area code assigned in Virginia, 571-434 is CO code assigned to Verizon Virginia, Inc. associated with the Herndon rate center and served from the switch HRDNVASTDS0, and 5400 is the line number assigned to the Neustar PBX. For a geographic TN the NPA is associated with a specific geographic area. For example, 202 is associated with Washington, DC. Non-geographic NPAs are nationwide, that is they are not associated with a specific geographic area. Today non-geographic NPAs are associated with a specific service and are used for traditional user to user voice and text service. For example, 800 is associated with toll free service.

FIG. 2 depicts the assignment of CO codes to specific switches. Networks use the association of a CO code to a switch to route calls. They route calls to a TN with the 703-465 CO code, to the EO to which 703-465 is assigned. At one time this meant that all ten thousand TNs within the CO code (703-465-0000 to 9999) had to be connected to the switch to which 703-465 was assigned. Local Number Portability (LNP) for geographic numbers allows TNs to be moved from one switch to another without moving the CO code.

To enable LNP another TN, called a Location Routing Number (LRN), is associated with the ported TN. The CO code of the LRN is associated with the new switch. Networks perform a query to an LNP database on the called TN, if an LRN is returned the network will route the call to the switch associated with the CO code of the LRN. That switch will complete the call to the ported TN. NP is limited to the geographic area associated with the TN's LATA. That is, a TN cannot be ported from a switch in one LATA to a switch in another LATA.

FIG. 3 illustrates the processing steps and porting process for a typical inter-service provider port. In this case, a user is switching to a new communications service provider and wants to keep his existing TN. First, at step 202, the new service provider notifies the old service provider of the requested port. At step 204, the old service provider is asked to validate the subscriber's information. The old service provider, at step 206, confirms the subscriber's information and notifies the new service provider. The new service provider, at step 208, notifies an administrative agency (e.g., the Number Portability Administration Center (NPAC) in the United States) of the requested port. Other countries have similar administrative agencies (e.g., Canadian Radio-television and Telecommunications Commission (CRTC) in Canada). The NPAC, at step 210, creates a pending port and sends a notification to the old service provider. Optionally, at step 212, the old service provider notifies the NPAC that it concurs with the port. The new service provider, at step 214, notifies the NPAC to activate the port. Finally, at step 216, the pending port is activated in the NPAC and a new NPAC record is created and broadcast to the telecommunications industry network. Each NPAC record, referred to as a Subscription Version, contains various pieces of information about the TN including, the TN, the current assigned service provider ID (SPID), the service provider type (such as wireless or wireline), the LRN, SS7 Destination Point Codes (Line Information Database (LIDB), Call ID with Name (CNAM), Custom Local Area Signaling Services (CLASS), etc.), service type (such as class 2 VoIP or pre-paid wireless), alternative SPID (to identify a reseller), billing ID, and end user location and type. However, portability is limited to the geographic area associated with the TN, and problems arise when the TN is ported from one geographic area to another.

There is a strong association between the PSTN and the geography associated with TNs. Carriers have built their switches, trunks and network routing based on the long history of LATAs and geographic number assignment. It is not possible to move a TN from NY to California in the current PSTN. The PSTN is evolving from older technology called Time Division Multiplex (TDM) or Circuit Switched (CS) or Signaling System 7 (SS7), to newer Internet Protocol (IP) technology. Because of this change there are no new features or capabilities being developed for TDM technology. Because IP is relatively new it has fewer restrictions when it comes to the geography associated with TNs.

### BRIEF DESCRIPTION OF THE DRAWINGS

The foregoing and other objects, features, and advantages of the invention will be apparent from the following description of preferred embodiments as illustrated in the accompanying drawings. The drawings are not necessarily to scale. Emphasis instead has been placed upon illustrating the principles of the invention.

FIGS. 1A-1C illustrate existing telecommunications networks;

FIG. 2 illustrates the assignment of CO codes to specific switches;

FIG. 3 illustrates the processing steps and porting process for a typical competitive port;

FIG. 4A is a block diagram illustrating an exemplary non-geographic call routing system according to an illustrative embodiment of the invention;

FIG. 4B is a block diagram illustrating an exemplary non-geographic call routing system according to an illustrative embodiment of the invention;

FIG. 5 illustrates some salient operations of a call-routing method according to an illustrative embodiment of the invention;

FIG. 6 illustrates some salient operations of a call-routing method according to an illustrative embodiment of the invention;

FIG. 7 illustrates some salient operations of a method to acquire a non-geographic routing number according to an illustrative embodiment of the present invention;

FIG. 8 illustrates some salient operations of a method to port a telephone number according to an illustrative embodiment of the present invention;

FIG. 9 illustrates some salient operations of a method to port a telephone number according to an illustrative embodiment of the present invention; and

FIG. 10 illustrates the components of a computer system implementing the non-geographic porting and call routing system according to various embodiments.

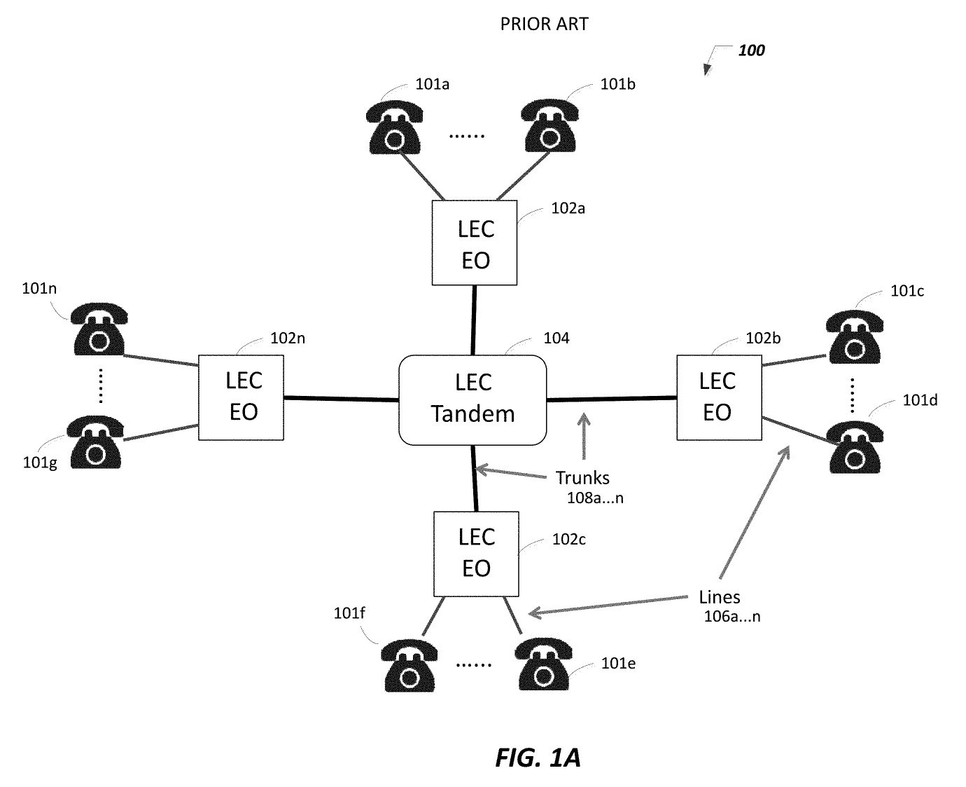

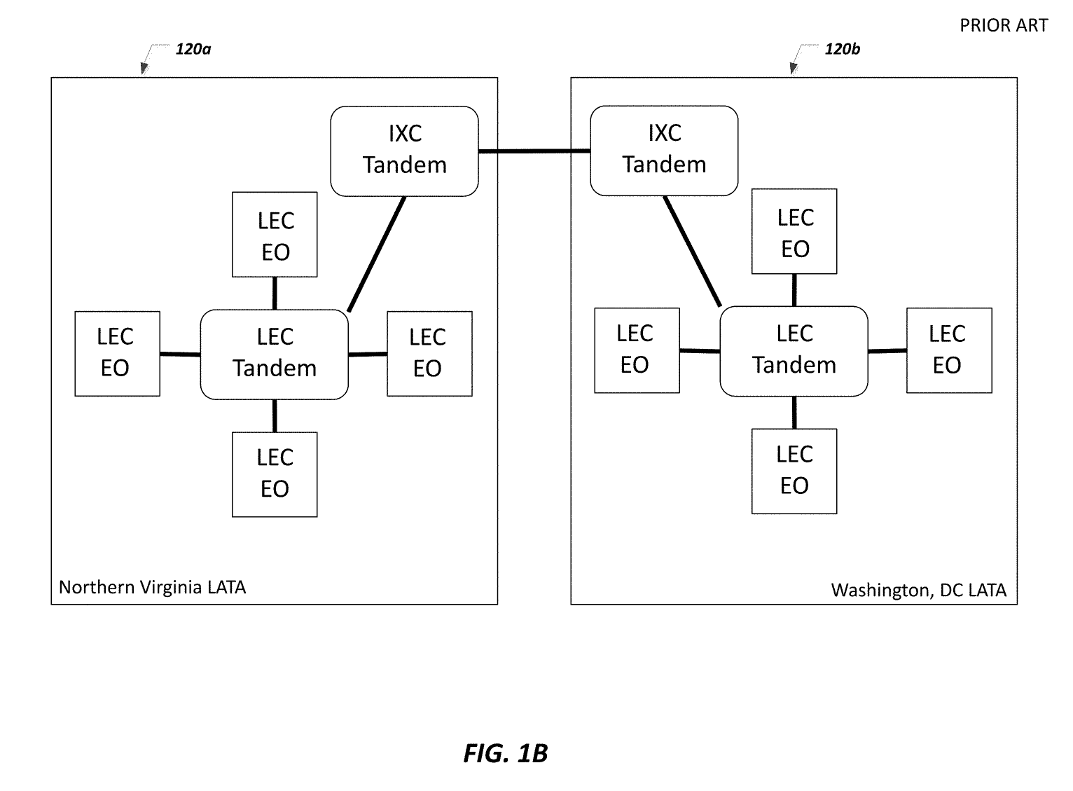

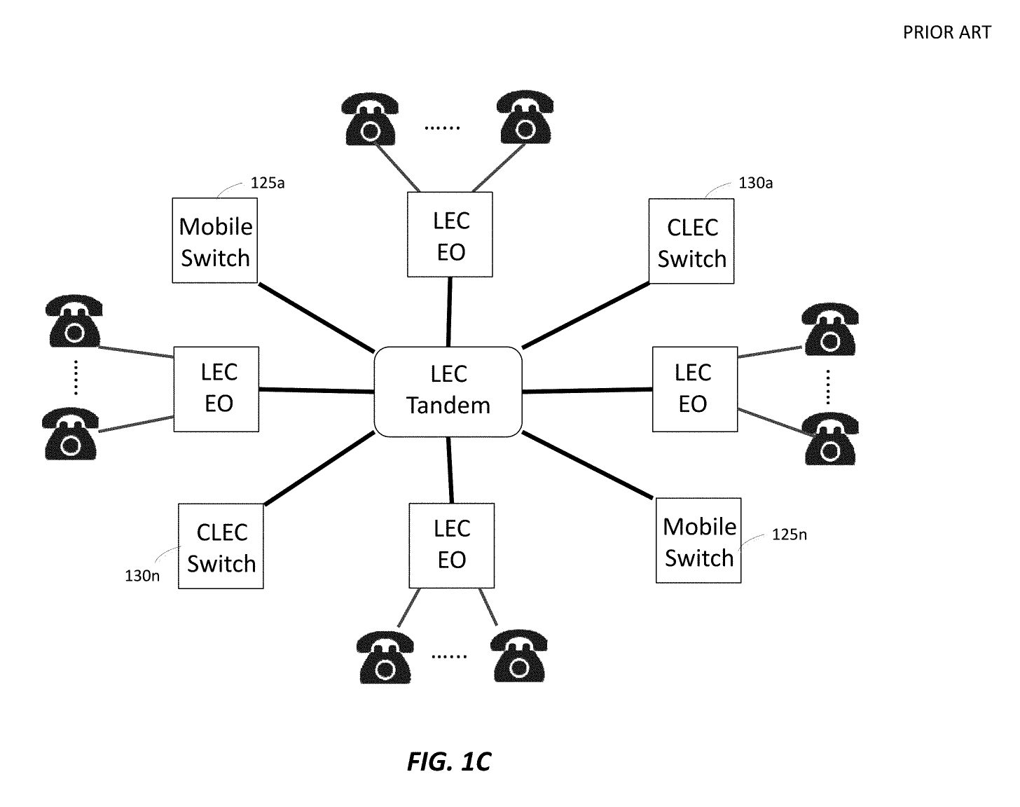

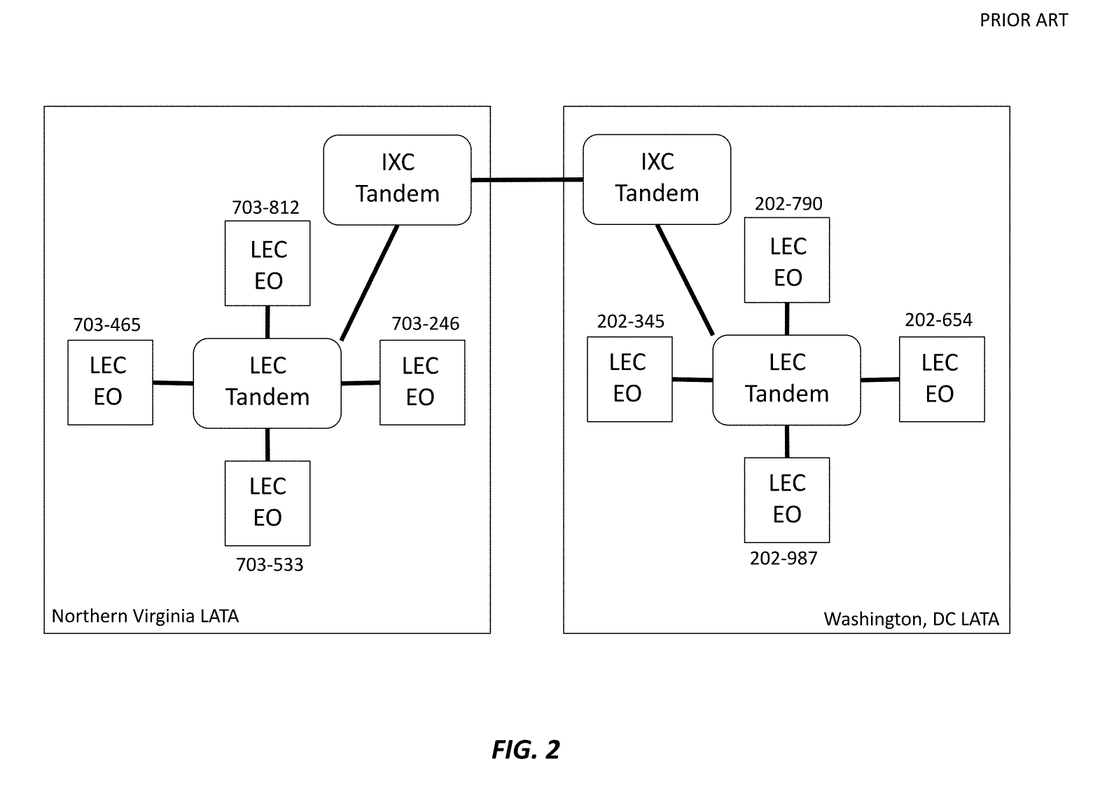

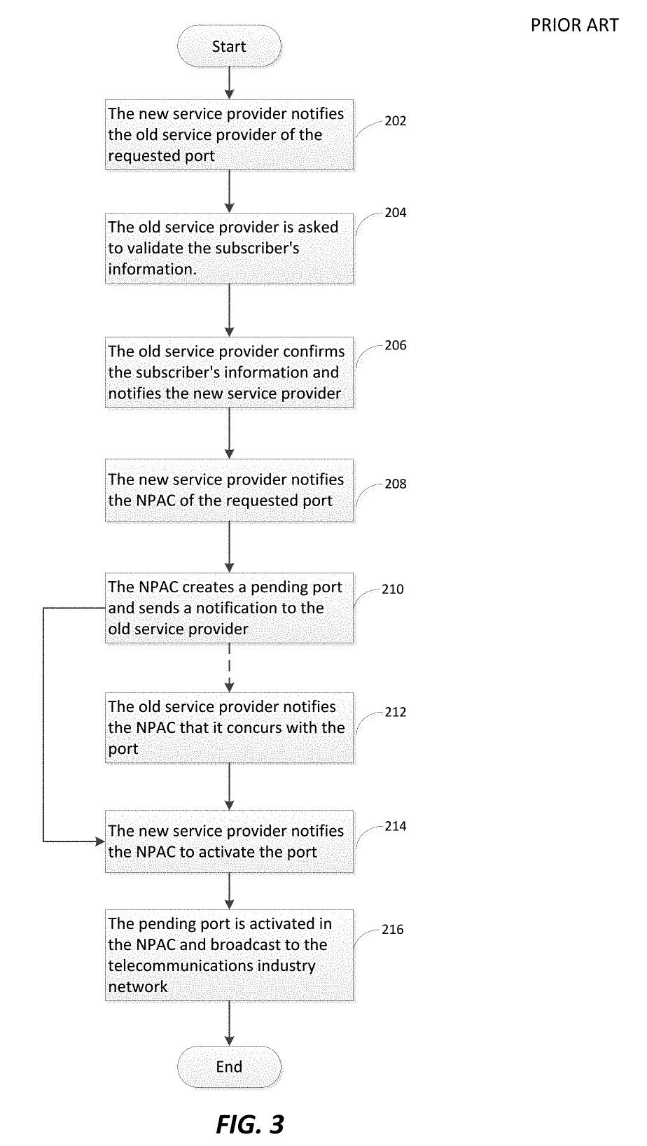

### DETAILED DESCRIPTION

Based on the foregoing, it is evident that there exists a need for a telecommunications network that is not dependent on the geography of a TN when routing a call to the TN. There also exists a need to have the ability to port a geographic TN to a different geographic area than the one to which it is associated and enable nationwide number portability (NNP). One way to enable NNP is to remove the NPAC edit and allow the TN and LRN to be in different geographic areas. However, there are many technical and operational aspects of the communications networks that rely on the TN and LRN being in the same geography. For example, a call of this type in certain older technology switches will fail. If so, then new software would have to be developed for these switches to implement this solution. It would also be unclear if a call made to such a ported geographic TN is an inter-LATA call (i.e., a long distance call) or not. It would also be unclear how and where the call to the ported TN would be billed.

To overcome these and other shortcomings of the existing solutions, an alternative solution is being presented that would use an IP-based communications network (IP PSTN) for telephone call routing. The IP PSTN may function in parallel with the existing TDM-based communications network. The IP PSTN may be hosted on an all-IP network comprising of IP Tandems, IP Transport Providers, etc. Because IP networks need to translate TNs into IP addressing information for call routing there would need to be an administrative function that associates TNs to IP addressing information. The IP PSTN could support call processing for non-geographic TNs (NGTNs) using the IP addressing information. NGTNs could be in a dedicated area code. Networks can use the area code to identify calls to TNs that need non-geographic call processing. The TDM PSTN would route calls to NGTNs to the IP PSTN for call processing. Geographic TNs could be transferred to the IP PSTN by using a non-geographic location routing number (NGLRN) from the non-geographic area code. A NGLRN is a TN used for routing. The geographic TN would be ported to the IP PSTN by associating it with a NGLRN. TDM PSTN networks would route calls to the NGLRN to the IP PSTN. Once a call is on the IP PSTN, IP addressing information associated with the NGLRN would be used to complete the call. NGTNs and NGLRNs are referred to as non-geographic numbering resources.

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail. Further, the terminology used in the description presented below is intended to be interpreted in its broadest reasonable manner, even though it is being used in conjunction with a detailed description of certain specific examples of the technology. Certain terms may even be emphasized below, however, any terminology intended to be interpreted in any restricted manner will be overtly and specifically defined as such in this Detailed Description section.

### Non-Geographic Telephone Number Call-Routing (IP Networks)

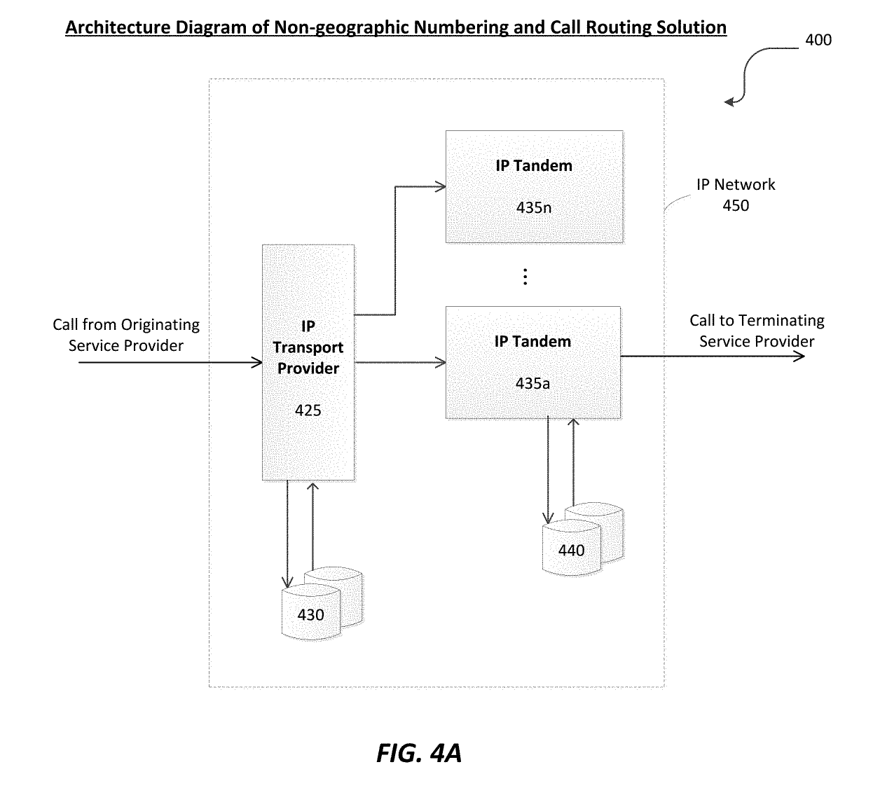

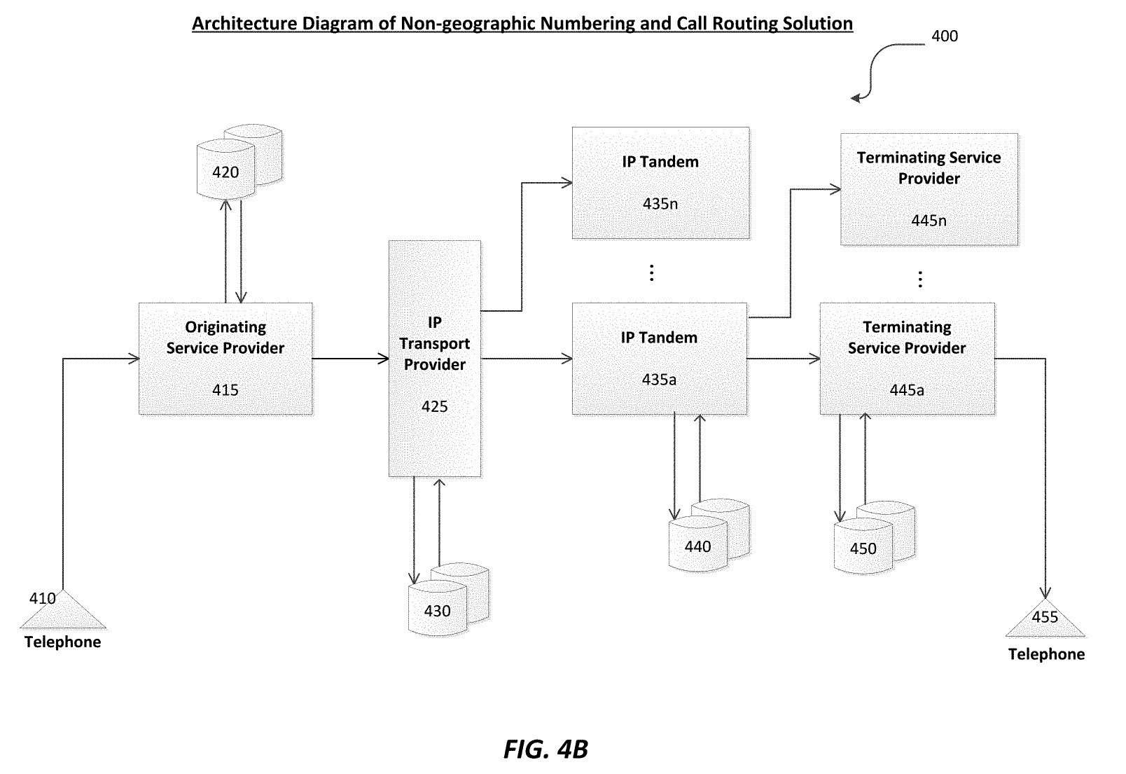

FIG. 4A shows a telecommunication system or network 400 for non-geographic numbering call routing according to some embodiments of the invention. The telecommunications network comprises of one or more IP transport providers 425. The IP transport providers 425 may be connected to one or more originating service providers through a communications medium over a network, such as the Internet. When an originating service provider receives a telephone call to a non-geographic telephone number (NGTN), it routes the telephone call to an IP network for further call processing. An IP transport provider 425 may be an IP network, consisting of Session Initiation Protocol (SIP) nodes and Real-Time Transport Protocol (RTP) nodes, etc., that can route the telephone call to the correct IP Tandem 45. In some embodiments of the invention, the IP transport provider 425 is managed by the same entity that manages the originating service provider. In another embodiment of the invention, the IP transport provider 425 is managed by an entity with which the originating service provider has an agreement for transport of non-geographic traffic. The IP transport provider 425 may have access to one or more databases which are configured to store information related to call routing. For example, the IP transport provider 425 may have access to one or more databases 430 that store, among other information, data related to NGTNs and their associated IP Tandem addressing information. In some embodiments of the invention, the IP Tandem associated with a NGTN can change. The IP Tandem addressing information may be the uniform resource locator (URL) that uniquely identifies the location of the IP Tandem. In embodiments of the invention, the IP Tandem addressing information may comprise of one or more of the following: service provider identifier, name of the company operating/maintaining the IP Tandem (e.g., Level3 switch 1), trunk group identifier, route server address, etc. Database 430 may be a localized version of a database maintained by an administrative agency which manages the addressing association between a NGTN and an IP Tandem 435a . . . 435n. The database 430 may be at or remote from the IP transport provider 425. An IP transport provider 425 may be connected to one or more IP Tandems 435a . . . 435n. While a NGTN is associated with only one IP Tandem, multiple NGTNs may be routed to a single IP Tandem. That is, a NGTN uniquely identifies one IP Tandem. And several NGTNs can identify the same IP Tandem for routing the telephone call.

An IP Tandem 435 comprises one or more IP network elements providing IP interconnection. The IP Tandem 435 can be thought of as an IP version of the existing LEC tandems. Service providers may establish their own IP Tandems. IP Tandems may also be maintained by a tandem provider that provides the services of its IP Tandems to one or more service providers. Irrespective of the entity managing the IP Tandems, it will be understood that, in some embodiments, each IP Tandem must be able to connect to every other IP Tandem to ensure call completion for non-geographic services. Furthermore, IP Tandem providers may need to be certified by an industry body, such as the industry body that certifies the NPAC. For example, it may be a requirement for IP Tandems to offer interconnection to any certified service provider. There may be certain uptime commitments.

The IP Tandem 435 has access to one or more databases 440 that store addressing information associated with one or more terminating service providers connected to the IP Tandem. The database(s) 440 may be at or remote from the IP Tandem 435. The addressing information associated with a terminating service provider comprises of information required to route the telephone call to the terminating service provider. Examples of such addressing information include, but are not limited to, a uniform resource locator, trunk group number, SIP address, route server address etc. The IP tandem may be connected to one or more terminating service providers through a communications medium over a network, such as the Internet. In some embodiments of the invention, the IP transport provider 425 and the IP Tandems 435a . . . n are the same entity (the IP Network 450). In some embodiments of the invention, the originating service provider, the IP transport provider 425, the IP Tandems 435a . . . n, and the terminating service provider may be the same entity (the IP Network).

### Non-Geographic Telephone Number Call-Routing (TDM Networks)

FIG. 4B shows a telecommunication system or network 400 for non-geographic numbering call routing according to some embodiments of the invention. The telecommunications network 400 includes a telephone 410 connected to an originating service provider 415 through a communications medium over a network, such as the Internet, trunk circuit, network of tandem switches, etc. In some embodiments of the invention, a dedicated pair of wires, called a line circuit or local loop, connect the telephone to the originating service provider 415 via a Serving Area Interface (SAI) (which generally looks like a large, green metal box placed on a street corner in the caller's neighborhood). From the SAI, large multi-conductor bundles of wires (each wire a local loop) travel to the originating service provider 415. The originating service provider 415 may be a mobile telecommunications service provider serving mobile stations. Alternatively, the originating service provider 415 may serve a fixed station. In some embodiments of the invention, the originating service provider 415 can be of a network type such as a public switched telephone network (PSTN) or integrated services digital network (ISDN). The originating service provider 415 may have access to one or more databases 420 which are configured to store information related to call routing. For example, the originating service provider 415 may have access to a database 420 that stores, among other information, data related to TNs and NGTNs. The database 420 may be at or remote from the originating service provider 415.

In a manner similar to that described in reference to FIG. 4A, the originating service provider 415 is connected through a communications medium over a network, such as the Internet, to one or more IP transport providers 425. The originating service provider 415, upon determining that the TN is a NGTN (e.g., based on the area code of the NGTN), would route the telephone call to an IP network for further call processing. In an embodiment of the invention, if the originating service provider is on a TDM-network, the originating service provider may route the call directly to an IP transport provider over an IP network based on the area code of the NGTN. An IP transport provider 425 may be an IP network, consisting of Session Initiation Protocol (SIP) nodes and Real-Time Transport Protocol (RTP) nodes, etc., that can route the telephone call to the correct IP Tandem 45. In some embodiments of the invention, the IP transport provider 425 is managed by the same entity that manages the originating service provider 415. In another embodiment of the invention, the IP transport provider 425 is managed by an entity with which the originating service provider 415 has an agreement for transport of non-geographic traffic. The IP transport provider 425 may have access to one or more databases which are configured to store information related to call routing. For example, the IP transport provider 425 may have access to one or more databases 430 that store, among other information, data related to NGTNs and their associated IP Tandem addressing information. In some embodiments of the invention, the IP Tandem associated with a NGTN can change. The IP Tandem addressing information may be the uniform resource locator (URL) that uniquely identifies the network address of the IP Tandem. In embodiments of the invention, the IP Tandem addressing information may comprise of one or more of the following: service provider identifier, name of the company operating/maintaining the IP Tandem (e.g., Level3 switch 1), trunk group identifier, route server address, port identifier, IP address, Uniform Resrouce Identifier (URI), Uniform Resource Name (URN), digital identity, etc. Database 430 may be a localized version of a database maintained by an administrative agency which manages the addressing association between a NGTN and a IP Tandem 435a . . . 435n. The database 430 may be at or remote from the IP transport provider 425. An IP transport provider 425 may be connected to one or more IP Tandems 435a . . . 435n. While a NGTN is associated with only one IP Tandem, multiple NGTNs may be routed to a single IP Tandem. That is, a NGTN uniquely identifies one IP Tandem. And several NGTNs can identify the same IP Tandem for routing the telephone call.

The IP Tandem 435 has access to one or more databases 440 that store addressing information associated with one or more terminating service providers 445a . . . 445n connected to the IP Tandem. The database(s) 440 may be at or remote from the IP Tandem 435. The addressing information associated with a terminating service provider comprises of information required to route the telephone call to the terminating service provider. Examples of such addressing information include, but are not limited to, a uniform resource locator, trunk group number, SIP address, route server address etc. The IP Tandem is connected, through a communications medium over a network, such as the Internet, trunk circuit, network of tandem switches, etc., to one or more terminating service providers 445a . . . 445n. Each terminating service provider 445a . . . 445n contains infrastructure, such as a database 450, to store and determine the routing information to route the telephone call to a telephone 455 of the end-user. In some embodiments of the invention, calls terminating on a IP Tandem 435 will be transported over an IP network.

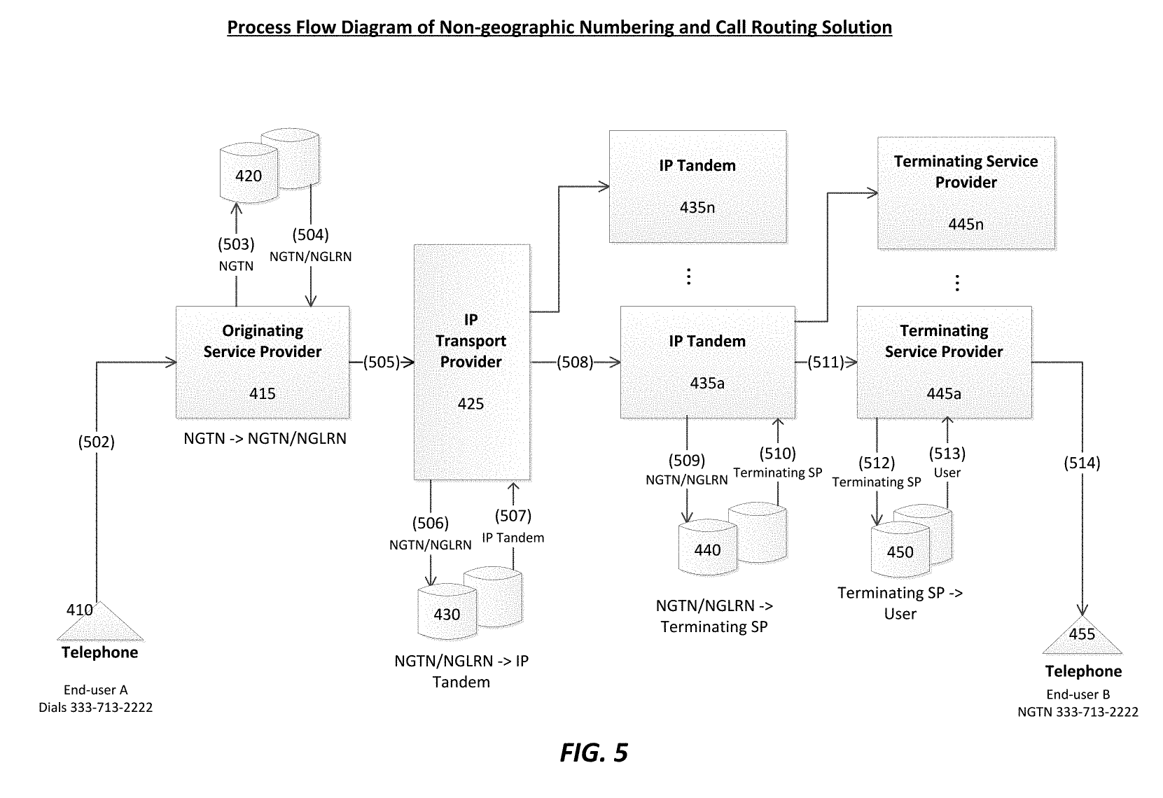

FIG. 5 depicts some salient operations of a call-routing method according to an illustrative embodiment of the invention. At step (502), end-user A dials end-user B (NGTN: 333-713-2222) using telephone 410. The call is routed to the originating service provider 415. The originating service provider 415, at step (503), queries one or more associated databases 420 to determine call addressing information associated with a NGTN. The databases 420 may be regularly updated by the administrative agency that manages the provisioning and administration of the NGTNs. The originating service provider 415 receives, at step (504), any call addressing information associated with the dialed TN, including an indication that the dialed TN is a NGTN. The call addressing information associated with the dialed TN may comprise one or more of the following: IP Tandem address, geographic telephone number, non-geographic telephone number, location routing number, non-geographic location routing number, uniform resource locator, uniform resource name, uniform resource identifier, outbound port identifier, trunk group identifier, IP address, digital identity, and service provider identifier. Once the originating service provider 415 determines that the TN is a NGTN, it then knows to forward the call, at step (505), to the IP PSTN instead of the TDM PSTN. For example, instructions at the originating service provider 415 inform it that, upon determining that the dialed TN is a NGTN, it should route the call directly to the IP transport provider 425 for NGTN call routing procedures. The IP network could be the service provider's own IP network or one they have an agreement with for this purpose.

At step (505), the IP transport provider 425 receives the dialed NGTN (333-979-1000). The IP transport provider 425, at step (506), queries one or more databases 430 to determine information related to the IP Tandems associated with the NGTN received from the originating service provider 415. The databases 430 may be regularly updated by the administrative agency that manages the provisioning and administration of the NGTNs. In some embodiments of the invention, the databases 430 store a mapping between a NGTN and a IP Tandem to which the call should be routed. One NGTN may only map to one IP Tandem. However, different NGTNs may be mapped to the same IP Tandem. That is, a many-to-one (n-to-1) association may exist between NGTNs and a IP Tandem. As discussed above, the databases 430 store IP Tandem addressing information for the associated IP Tandems 445a . . . 445n. At step (507), the IP transport provider 425 receives the IP Tandem addressing information (e.g., a URL) for the IP Tandem associated with the NGTN. The IP Tandem information may comprise one or more of the following: IP Tandem address, geographic telephone number, non-geographic telephone number, location routing number, non-geographic location routing number, uniform resource locator, uniform resource name, uniform resource identifier, outbound port identifier, trunk group identifier, IP address, digital identity, and service provider identifier. The IP transport provider 425 then routes the call, at step (508) to the identified IP Tandem 435a based on the IP Tandem addressing information.

The IP Tandem 435a, at step (509), queries one or more databases 440 to determine information related to the terminating service provider 445a . . . 445n to which the call is to be routed to complete the call. The terminating service provider is the service provider which serves the NGTN. It may be the same as the originating service provider. An IP Tandem 435a may serve one or more terminating service providers 445a . . . 445n. In some embodiments of the invention, a IP Tandem is dedicated to only one terminating service provider. In such a case, the terminating service provider may provision, manage and administer the IP Tandem. Alternatively, a third party may perform one or more of the provisioning, management and administration functions. In another embodiment of the invention, an IP Tandem serves two or more terminating service providers. This typically occurs when the IP Tandem is provisioned, managed and administered by a third party that provides the services of its IP Tandems to service providers.

As discussed above, databases 440 store addressing information associated with a terminating service provider, such as, a uniform resource locator (URL), trunk group number, SIP address, etc. At step (510), the IP Tandem 435a receives the terminating service provider addressing information (e.g., a trunk group number) for the terminating service provider associated with the TN. This addressing information is used by the IP Tandem to route the call, at step (511) to the appropriate terminating service provider 445a for call completion. The terminating service provider 445a too has access to one or more databases 450 which store routing information to route the telephone call to a telephone 455 of the end-user. The terminating service provider 445a may query this information based on the dialed TN (step (512)) and receive it from the databases 450 (step (513)). Finally, at step (514), the terminating service provider 445a completes the call from End-user A to End-user B.

In some embodiments where the IP transport provider and the IP Tandems are the same entity (the IP Network), the originating service provider 415 may route the call to the IP Network based on the call addressing information. The IP Network may then route the call to the terminating service provider 445a . . . 445n based on the call addressing information and/or the IP routing information stored in one or more IP mapping databases. The IP routing information may comprise one or more of the following: IP Tandem address, geographic telephone number, non-geographic telephone number, location routing number, non-geographic location routing number, uniform resource locator, uniform resource name, uniform resource identifier, outbound port identifier, trunk group identifier, IP address, digital identity, and service provider identifier.

### Ported Telephone Number Call-Routing (Using NGLRNs)

Calls can be routed to geographic TNs which have been ported to the non-geographic network. A non-geographic location routing number (NGLRN) may be used to route calls to ported to a different geography using the number porting method discussed in detail below. A NGLRN is a routing number associated with a TN for the purposes of call routing. A NGLRN may be in a pre-determined format. For example, a NGLRN may be of similar format as a TN and comprise of ten digits in the following format: NXX-NXX-XXXX, where N are digits from 2-9 and X is digits from 0 to 9. The first three digits, called the NPA or area code, may be non-geographic. In some embodiments of the invention, NGLRNs are assigned to a service provider and an IP Tandem on a ten-digit basis and not a six-digit basis as opposed to CO codes which are assigned on a six-digit basis to an EO. Further, the non-geographic area code may not designate a specific geographic region and is considered nationwide. In some embodiments of the invention, the non-geographic area codes are a new numbering resource that are served solely by Internet Protocol (IP) networks. For example, NGLRNs may be hosted on an all-IP network of switches rather than the existing TDM tandems and EOs. The non-geographic area code would indicate to older technology infrastructure and the TDM PSTN the need to send the call to an IP network for call processing. Each NGLRN is associated with a service provider and a IP Tandem.

The non-geographic area code can also be used for TN assignment to users (i.e., NGTNs). That is, service providers can assign TNs from the non-geographic area code to users. NGTNs may have an associated NGLRN. Calls to NGTNs may be routed based on the NGLRN. In some embodiments of the invention, calls to NGTNs are routed based on the NGTN itself and no look-up for the NGLRN is performed. The service provider, NGLRN, and IP Tandem associated with a NGLRN can change.

NGLRNs and NGTNs may be managed and administered by a central administrative entity. As a result, the telecommunications industry may implement administrative processes that are more advanced than existing processes that need to account for legacy PSTN networks. For example, existing administrative processes, such as allocation and porting, that are handled by different parties may be combined. Alternatively, existing administrative processes that are handled by a single authoritative registry may be handled by multiple distributed registries (including, but not limited to, using blockchain technology), all managing the same information. The existing administrative processes may be integrated with existing processes such as North American Numbering Plan Administration (NANPA), National Number Pool Administration (PA), Local Exchange Routing Guide (LERG) and Local Number Portability Administration (LNPA). A service provider may acquire a NGLRN (or NGTN) from an administrative agency by following a set of steps discussed below in more detail.

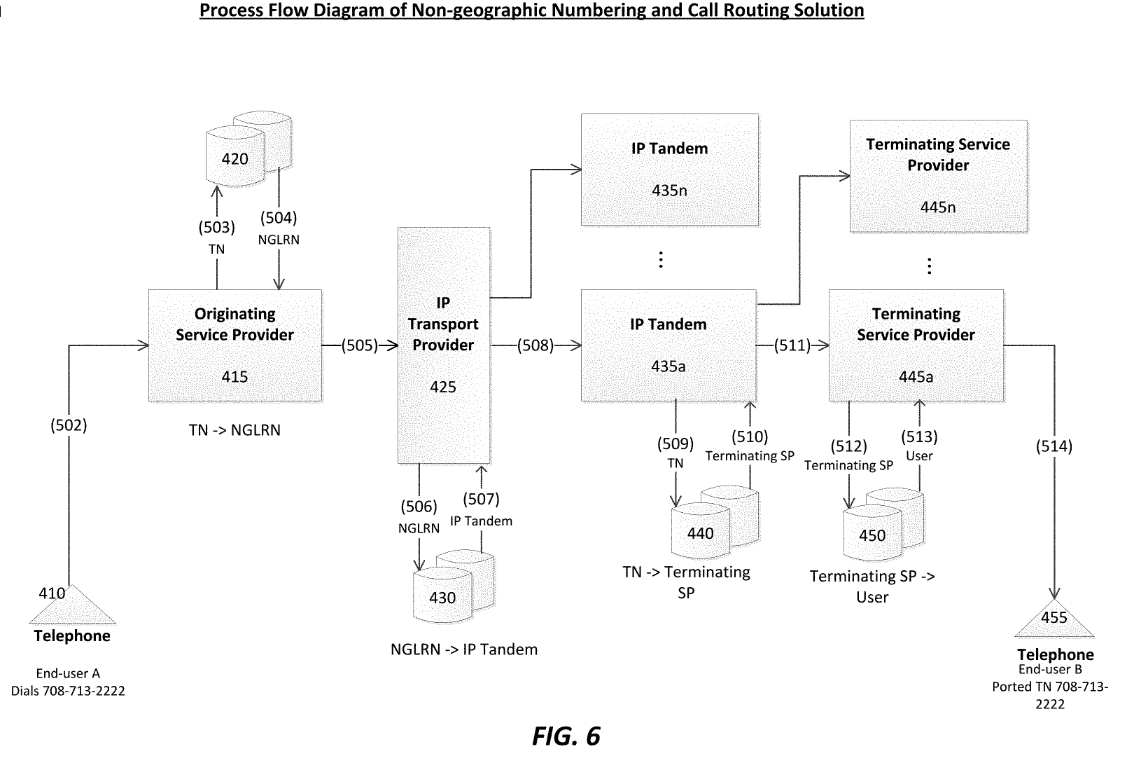

FIG. 6 depicts some salient operations of a call-routing method for a call to a ported TN. The TN may be ported from the TDM PSTN to the IP PSTN or an NGLRN. At step (502), end-user A dials end-user B (TN:708-713-2222) using telephone 410. Assume that end-user B (708-713-2222) ports his number to a different geography using the number porting method discussed in detail below. The call is routed to the originating service provider 415. The originating service provider 415, at step (503), queries one or more associated databases 420 to determine whether a routing number is associated with the dialed TN. The databases 420 may be regularly updated by the administrative agency that manages the provisioning and administration of the NGLRNs and NGTNs. The originating service provider 415 receives, at step (504), any addressing information associated with the TN, including any routing number (333-979-1000). The originating service provider 415 determines that the routing number associated with the TN is a NGLRN. The area code of the NGLRN (333) may be dedicated to NGLRNs. The originating service provider 415 then knows to forward the call, at step (505), to an IP transport provider 425 on an IP network to complete the call. That is, instructions at the originating service provider 415 inform it that, upon determining that the routing number is a NGLRN, it should route the call directly to the IP transport provider 425 for NGLRN call routing procedures. The IP network could be the service provider's own IP network or one they have an agreement with for this purpose.

In addition to receiving the routed call at step (505), the IP transport provider 425 also receives the dialed TN (708-713-2222) and the associated NGLRN (333-979-1000). The IP transport provider 425, at step (506), queries one or more databases 430 to determine information related to the IP Tandems associated with the NGLRN received from the originating service provider 415. The databases 430 may be regularly updated by the administrative agency that manages the provisioning and administration of the NGLRNs and NGTNs. In some embodiments of the invention, the databases 430 store a mapping between a NGLRN and a IP Tandem to which the call should be routed. One NGLRN may only map to one IP Tandem. However, different NGLRNs may be mapped to the same IP Tandem. That is, a many-to-one (n-to-1) association may exist between NGLRNs and a IP Tandem. As discussed above, the databases 430 store IP Tandem addressing information for the associated IP Tandems 435a . . . 435n. At step (507), the IP transport provider 425 receives the IP Tandem addressing information (e.g., a URL) for the IP Tandem associated with the NGLRN. The IP transport provider 425 then routes the call, at step (508) to the identified IP Tandem 435a based on the IP Tandem addressing information.

The IP Tandem 435a, at step (509), queries one or more databases 440 to determine information related to the terminating service provider 445a . . . 445n to which the call is to be routed to complete the call. The terminating service provider is the service provider to which the TN has been ported. It may be the same as the originating service provider. In some embodiments of the invention, the databases 440 store a mapping between the TN and the address information of the terminating service provider to which the TN has been ported. A IP Tandem 435a may serve one or more terminating service providers 445a . . . 445n. In some embodiments of the invention, a IP Tandem is dedicated to only one terminating service provider. In such a case, the terminating service provider may provision, manage and administer the IP Tandem. Alternatively, a third party may perform one or more of the provisioning, management and administration functions. In another embodiment of the invention, a IP Tandem serves two or more terminating service providers. This typically occurs when the IP Tandem is provisioned, managed and administered by a third party that provides the services of its IP Tandems to service providers.

As discussed above, databases 440 store addressing information associated with a terminating service provider, such as, a uniform resource locator (URL), trunk group number, SIP address, etc. At step (510), the IP Tandem 435a receives the terminating service provider addressing information (e.g., a trunk group number) for the terminating service provider associated with the TN. This addressing information is used by the IP Tandem to route the call, at step (511) to the appropriate terminating service provider 445a for call completion. The terminating service provider 445a too has access to one or more databases 450 which store routing information to route the telephone call to a telephone 455 of the end-user. The terminating service provider 445a may query this information based on the TN called (step (512)) and receive it from the databases 450 (step (513)). Finally, at step (514), the terminating service provider 445a completes the call from End-user A to End-user B.

### Non-Geographic Telephone Number Porting

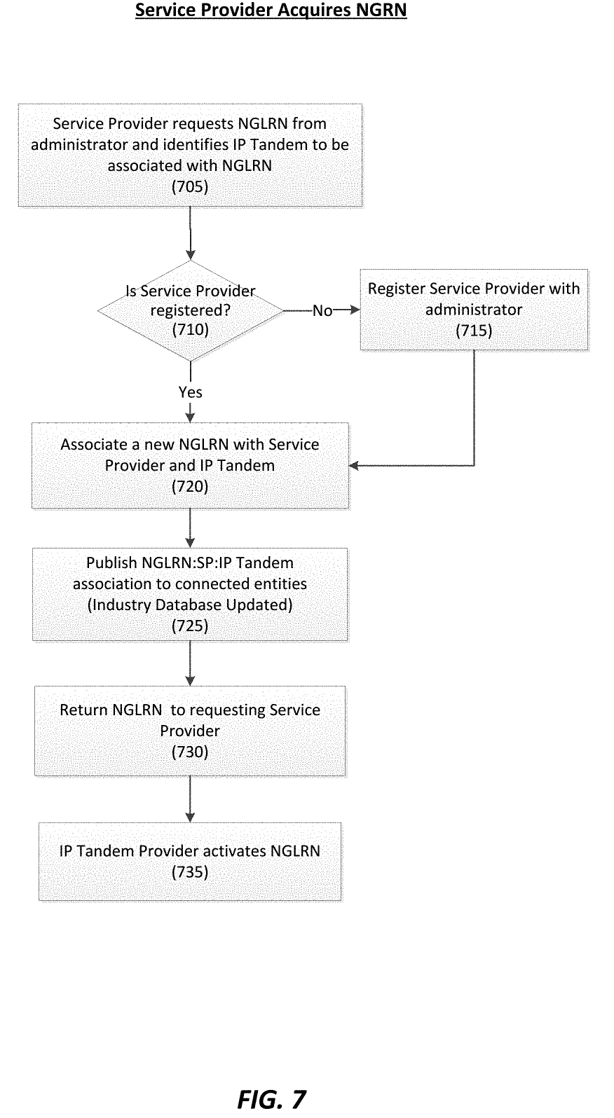

A service provider acquires a NGLRN so that it can begin to offer nationwide number portability. FIG. 7 depicts some salient operations of a method to acquire a NGLRN according to an illustrative embodiment of the present invention. One or more administrative entities may manage the allocation of NGLRNs to service providers, that is, administer the non-geographic area code. At step (705), as part of the acquisition process, a service provider requesting a NGLRN may submit administrative and service data related to providing service for the NGLRN. Examples of data include, but are not limited to, service provider name, service provider contact, IP Tandem provider name, IP Tandem contact, IP Tandem address, and NGLRN, billing identifier, etc. The administrator, upon receiving such a request, may check if the requesting service provider is registered (step (710)). If the service provider is not registered, at step (715), the administrator registers the service provider. On the other hand, if the service provider is registered, then at step (720), the administrator would associate the new NGLRN with the requesting service provider and the IP Tandem identified by the service provider. The service provider and the IP Tandem provider can be the same company. The administrator may make the data associating the NGLRN, service provider, and the IP Tandem available to others based on local policies (step (725)). For example, the administrator may update or create a record in the databases connected to the IP transport provider (shown in FIGS. 4 and 5). It can do this by providing an API or by distributing the data. Administrative data is more likely provided by API, reference addresses and service data could be provided by distribution. The administrator then returns the NGLRN to the service provider (step (730)) which then activates the new NGLRN at step (735). There may be policies as to which and how many NGLRNs a service provider can request. In some embodiments, the service provider could request a specific geographic routing number. In some embodiments, the administrator assigns a NGLRN randomly or in sequence. The administrator may place some limitation on how many NGLRNs a service provider can request (e.g., some number per tandem).

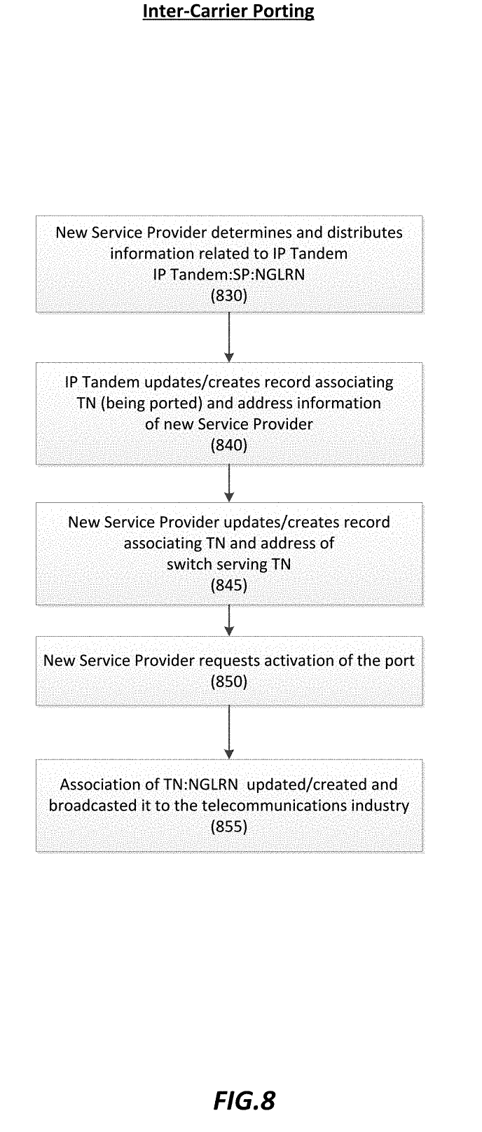

FIG. 8 depicts some salient operations of a method to port a geographic TN to the non-geographic IP PSTN according to an illustrative embodiment of the present invention. In this example, a user is switching to a new communications service provider (likely in a new geographic area with a different area code) and wants to keep his existing TN. A TN porting request may originate in several ways. In one example, the new service provider may notify the old service provider of the requested port. The old service may then validate and confirm the subscriber's information and notify the new service provider. In another example, the new service provider may simply inform the old service provider that the TN is being ported, without requiring any validation or confirmation of the subscriber's information. In another example, the subscriber may use a credential to request a telephone port. The new service provider may verify the credential and process the port request. Examples of credentials include a username, password, verification code, digital certificate etc.

Once a port has been initiated, the new service provider, at step (830), determines and distributes information related to the IP Tandem that will be used to route calls to the ported TN. This information may include, but is not limited to, the NGLRN, service provider data, IP Tandem addressing information, etc. This information may be made available to others based on local policies. For example, in some embodiments of the invention, an administrator may update or create a record in the databases connected to the IP transport provider (shown in FIGS. 4 and 5). It can do this by providing an API or by distributing the data. Administrative data is more likely provided by API, reference addresses and service data could be provided by distribution. The administrator also creates a pending port and sends a notification to the old service provider. Then, at step (840), the IP Tandem associated with the NGLRN updates or creates a record in its databases (e.g., databases 440 in FIGS. 4 and 5), associating the TN being ported and the addressing information associated with the new service provider. The new service provider, at step (845), also updates or creates a record in its databases (e.g., databases 450 in FIGS. 4 and 5), associating the TN being ported and the routing information to route the telephone call to the new geographic location. In some embodiments of the invention, when porting a geographic TN to a NGLRN, the association between the ported TN area code and its regional administrative agency may be maintained. For example, if a 708 TN is being ported to a NGLRN, it could be ported in the Midwest regional NPAC.

The new service provider, at step (850), also requests the activation of the port. For example, the new service provider may notify an administrator to activate the port. The pending port is activated and a new record associating the TN with the NGLRN is created and broadcast to the telecommunications industry at step (855). Each record may contain various pieces of information including service information and administrative information. Examples of service information include: LRN, NGLRN and destination point code. Examples of administrative information include: PIN and billing identifier. Each record can contain various pieces of information about the TN including, the TN, the current assigned service provider ID (SPID), the service provider type (such as wireless or wireline), the NGLRN, SS7 Destination Point Codes (Line Information Database (LIDB), Call ID with Name (CNAM), Custom Local Area Signaling Services (CLASS), etc.), service type (such as class 2 VoIP or pre-paid wireless), Alternative SPID (to identify a reseller), billing ID, and end user location and type. In this way, portability is not limited to the geographic area associated with the TN, and a TN is ported from one geographic area to another.

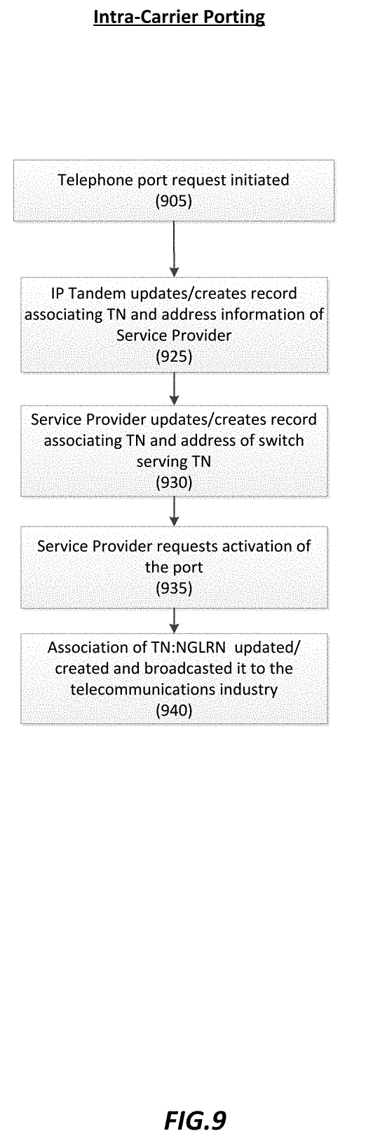

FIG. 9 depicts some salient operations of a method to port a TN according to an illustrative embodiment of the present invention. In this example, a user is maintaining its service provider but may likely be moving to a new geographic area with a different area code while keeping his existing TN. Therefore, the service provider would want to port him to the IP PSTN. Upon initiation of a port request (step (905)), the service provider associates a NGLRN with the geographic TN and updates the telecommunications industry with the new routing data. At step (925), the new IP Tandem, associated with the NGLRN, creates/updates a record in its databases (e.g., databases 440 in FIGS. 4 and 5), associating the TN being ported and the addressing information associated with the service provider. The service provider, at step (930), also updates or creates a record in its databases (e.g., databases 450 in FIGS. 4 and 5), associating the TN being ported and the routing information to route the telephone call to the new geographic location. In some embodiments of the invention, when porting a geographic TN to a NGLRN, the association between the ported TN area code and its regional administrative agency may be maintained. For example, if a 708 TN is being ported such that the new location of the user will be in New York, the telephone could be ported in the Midwest regional NPAC. In some embodiments of the invention, the ported TN may be associated with a new geographic region specifically reserved for non-geographic number porting (e.g., an eighth NPAC region). In some embodiments of the invention, a new administrative system may handle the porting of the TNs.

The service provider, at step (935), also requests activation of the port. The pending port is activated and a new record is created and broadcast to the telecommunications industry network at step (940). Each record may contain various pieces of information about the TN including, the TN, the current assigned service provider ID (SPID), the service provider type (such as wireless or wireline), the NGLRN, SS7 Destination Point Codes (Line Information Database (LIDB), Call ID with Name (CNAM), Custom Local Area Signaling Services (CLASS), etc.), service type (such as class 2 VoIP or pre-paid wireless), Alternative SPID (to identify a reseller), billing ID, and end user location and type. In this way, portability is not limited to the geographic area associated with the TN, and a TN is ported from one geographic area to another.

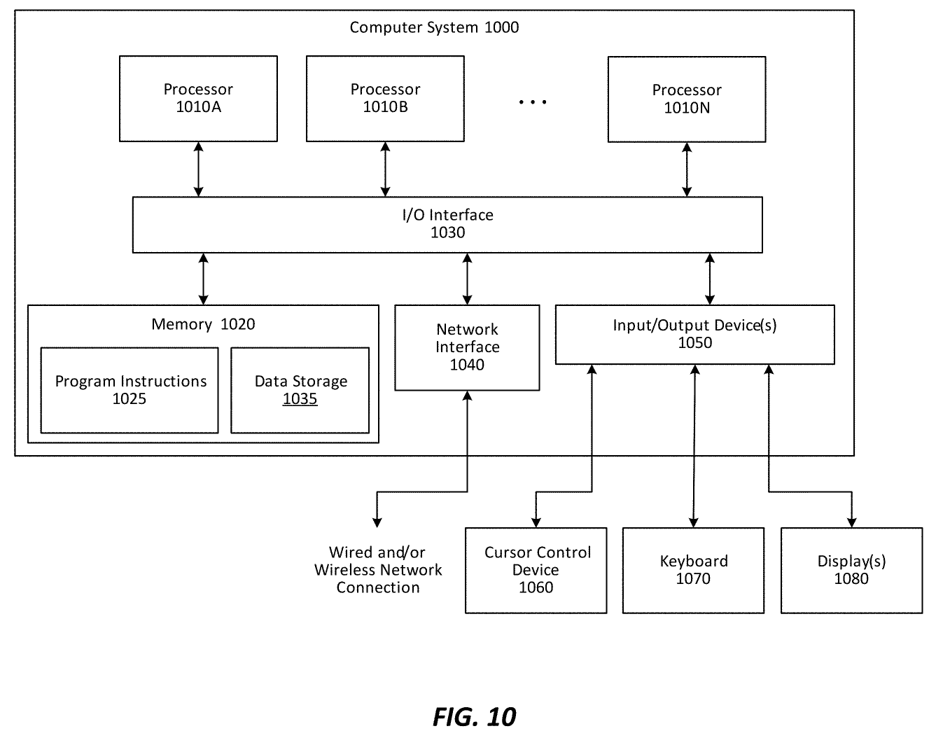

FIG. 10 illustrates the components of a computer system implementing the non-geographic porting and call routing system according to various embodiments. The IP transport provider illustrated in FIGS. 4 and 5 may be implemented or executed, at least in part, by one or more computer systems. In various embodiments, computer system 1000 may be a server, a workstation, a desktop computer, a laptop, a microcontroller, a system on a chip or the like. In some embodiments of the invention, computer system 1000 may be implemented using a cloud-based infrastructure. In some embodiments, system 1000 may be used to implement the call routing functionalities of FIGS. 4 and 5. As illustrated, computer system 1000 includes one or more processor(s) 1010A-N coupled to a system memory 1020 via an input/output (I/O) interface 1030. Computer system 1000 further includes a network interface 1040 coupled to I/O interface 1030, and one or more input/output devices 1050, such as cursor control devices 1060, keyboard 1070, and display(s) 1080.

In various embodiments, computer system 1000 may be a single-processor system including one processor 1010A, or a multi-processor system including two or more processors 1010A-N (e.g., two, four, eight, or another suitable number). Processor(s) 1010A-N may include any processor capable of executing program instructions. For example, in various embodiments, processor(s) 1010A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processor(s) 1010A-N may commonly, but not necessarily, implement the same ISA.

System memory 1020 may be configured to store program instructions (e.g., the real-time communications controller functions) and/or data accessible by processor(s) 1010A-N. In various embodiments, system memory 1020 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in connection with FIGS. 4 and 5, may be stored within system memory 1020 as program instructions 1025 and data storage 1035, respectively. Additionally or alternatively, the real-time communications controller functions may be a software program that is stored within system memory 1020 and is executable by processor(s) 1010A-N. In other embodiments, program instructions and/or data may be received, sent or stored upon different types of computer-accessible media or on similar media separate from system memory 1020 or computer system 1000. Generally speaking, a computer-accessible medium may include any tangible or non-transitory storage media or memory media such as electronic, magnetic, or optical media—e.g., disk or CD/DVD-ROM coupled to computer system 600 via I/O interface 1030. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, I/O interface 1030 may be configured to coordinate I/O traffic between processor(s) 1010A-N, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor(s) 1010A-N). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor(s) 1010A-N.

Network interface 1040 may be configured to allow data to be exchanged between computer system 1000 and other devices attached to a network, such as an embedded real-time client and one or more mobile devices. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, RFID readers, NFC readers, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 600 through a wired or wireless connection, such as over network interface 1040.

As shown in FIG. 10, memory 1020 may include program instructions 1025, configured to implement certain embodiments described herein, and data storage 1035, comprising various data may be accessible by program instructions 1025. In an embodiment, program instructions 1025 may include software elements of embodiments illustrated in the above figures. For example, program instructions 1025 may be implemented in various embodiments using any desired programming language, scripting language, or combination of programming languages and/or scripting languages (e.g., C, C++, C#, .NET, Java™ JavaScript™, Perl, etc.). Data storage 1035 may include data that may be used in these embodiments (e.g., recorded communications, profiles for different modes of operations, etc.). In other embodiments, other or different software elements and data may be included.

The above description of the workings of this technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

From the foregoing, it will be appreciated that specific embodiments of the invention have been described herein for purposes of illustration, but that various modifications may be made without deviating from the scope of the invention. Accordingly, the invention is not limited except as by the appended claims.

1. A telecommunications network for routing a telephone call comprising:
at least one IP network configured to receive at least one telephone call comprising call addressing information from an originating service provider; and
at least one IP mapping database, communicatively coupled via a distributed network with the IP network, configured to store IP routing information associated with a non-geographic numbering resource, wherein the IP network forwards the telephone call for routing to a terminating service provider, in accordance with the IP routing information stored in the IP mapping database and the call addressing information.

2. The telecommunications network of claim 1, wherein the call addressing information comprises at least one of:
IP Tandem address
non-geographic telephone number;
location routing number;
non-geographic location routing number;
uniform resource locator;
uniform resource name;
uniform resource identifier;
outbound port identifier;
trunk group identifier;
IP address;
digital identity; and
service provider identifier.

3. The telecommunications network of claim 1, wherein the IP routing information comprises at least one of:
IP Tandem address;
geographic telephone number;
non-geographic telephone number;
location routing number;
non-geographic location routing number;
uniform resource locator;
uniform resource name;
uniform resource identifier;
outbound port identifier;
trunk group number;
IP address;
digital identity; and
service provider identifier.

4. The telecommunications network of claim 1 wherein at least two of the following are the same:
the originating service provider;
the IP network; and
the terminating service provider.

5. The telecommunications network of claim 1 wherein the IP network comprises at least one of:
IP transport provider; and
IP tandem.

6. The telecommunications network of claim 1 further comprising:
at least one switch configured to receive the telephone call from the IP network based on the call addressing information, wherein the switch terminates the telephone call to a terminating telephone.

7. The telecommunications network of claim 1 wherein the call addressing information is of a predetermined format.

8. The telecommunications network of claim 1 wherein the IP network implements Internet Protocol technology.

9. A method for routing a telephone call to a telephone number in a telecommunications network, the method comprising:
receiving, at an IP network, a telephone call from an originating service provider based on call addressing information associated with the telephone number;
determining, at the IP network, IP routing information based on the call addressing information, wherein the IP routing information is stored in a IP mapping database communicatively coupled via a distributed network with the IP network; and
routing the telephone call to a terminating service provider, in accordance with the IP routing information stored in the IP mapping database and the call addressing information.

10. The method of claim 9, wherein the call addressing information comprises at least one of:
IP Tandem address;
geographic telephone number;
non-geographic telephone number;
location routing number;
non-geographic location routing number;
uniform resource locator;
uniform resource name;
uniform resource identifier;
outbound port identifier;
trunk group identifier;
IP address;
digital identity; and
service provider identifier.

11. The method of claim 9, wherein the IP routing information comprises at least one of:
IP Tandem address;
geographic telephone number;
non-geographic telephone number;
location routing number;
non-geographic location routing number;
uniform resource locator;
uniform resource name;
uniform resource identifier;
outbound port identifier;
trunk group identifier;
IP address;
digital identity; and
service provider identifier.

12. The method of claim 9, wherein at least two of the following are the same:
the originating service provider;
the IP network; and
the terminating service provider.

13. The method of claim 9, wherein the IP network comprises at least one of:
IP transport provider; and
IP tandem.

14. The method of claim 9 further comprising:
updating, by an administrative service provider, IP routing information associated with the IP network.

15. The method of claim 9, wherein the call addressing information is of a predetermined format.

16. The method of claim 9 wherein the IP network implements Internet Protocol technology.

17. A method for porting a telephone number assigned to a subscriber, from an old service provider to a new service provider in a telecommunications network, the method comprising:
receiving, at the new service provider, information associated with the subscriber;
determining, at the new service provider, IP routing information of at least one IP network required to route a telephone call to the telephone number;
transmitting, from the new service provider, the IP routing information of at least one IP network for porting the telephone number, to one or more service providers in the telecommunications network; and
receiving, at the new service provider, a port completion notice.

18. The method of claim 17 wherein the IP routing information comprises at least one of:
IP Tandem address;
geographic telephone number;
non-geographic telephone number;
location routing number;
non-geographic location routing number;
uniform resource locator;
uniform resource name;
uniform resource identifier;
outbound port identifier;
trunk group identifier;
IP address;
digital identity; and
service provider identifier.

19. The method of claim 17 wherein the IP routing information of the at least one IP network is determined based on location of a terminating end-office associated with the ported telephone number.

20. The method of claim 17 wherein the old service provider is the same as the new service provider.
